(19) United States
(12) Patent Application Publication
(10) Pub. No.: US 2009/0014584 A1
(43) Pub. Date: Jan. 15, 2009

(54) Tracks, Power, and Data Blocks and Releasable Fastening System

(75) Inventors: Dickory Rudduck, Chicago, IL (US); Lee David Blattmann, Wilmette, IL (US); Geoffrey David Sizer, Chicago, IL (US)

Correspondence Address: TELEZYGOLOGY, INC., 520 W. ERIE STREET, SUITE 210, CHICAGO, IL, 60654, US

(73) Assignee: TELEZYGOLOGY INC, Sydney (AU)

(21) Appl. No.: 11/914,906

(22) PCT Filed: May 17, 2006
(86) PCT No.: PCT/AU06/00645

§ 371 Date: Jan. 22, 2008

(30) Foreign Application Priority Data
May 19, 2005 (AU) 2005902565

(51) Int. Cl. B64D 11/06; B60N 2/07; B60N 2/08

(52) U.S. Cl. 244/118.6; 307/9.1

(57) ABSTRACT

A track (20) for a relocatable seat including a first channel (22), having a slot opening into the track with a plurality regions where slot is enlarged. The enlarged regions receive a foot (50) of a seat and the non-enlarged regions of the slot retain the feet. The track includes a second and third channel for receiving a power block (54) and/or communication data block (58), and each including a plurality of apertures (44) for receiving a retractable tongue (76) on the blocks to locate the blocks in the track. The invention further relates to a releasable fastening system having two sleds (78, 80) for insertion in a track (20) and a locking lever (84) with an end (86, 88) connected to each sled. Each sled has at least one aperture (82) inclined towards the track. Movement of the locking lever from an open to a locked position causes a lug (92) inserted in the aperture to travel down the incline towards the track.

### FIELD OF THE INVENTION

This invention is concerned with a track system particularly suitable for securing and releasing aircraft seats to the body of the aircraft. The invention also has other aspects, as will be apparent from the discussion below.

### BACKGROUND OF THE INVENTION

Especially in large commercial aircraft, it is often desirable to remove and reinstall aircraft seats. This can be required in order to reconfigure aircraft seat layout. For example, it may be desirable to vary the number of first class, business class or economy seats. Seat pitch can vary from about 28 to 32 inches in economy to about 60 inches in business class, for example. It may be desirable to vary seat pitch, even within the same class.

There are many problems encountered in reconfiguring aircraft seats. One of these arises because modern aircraft seats require power and/or data to be delivered to each seat. Commonly, aircraft seats require power and/or data for calling flight attendants, for seat and footrest adjustment, for operating lights and sound systems, for operating entertainment modules such as video/DVD players, for operating computers including Internet access, for telephones, and so on. As a result, each aircraft seat is associated with a significant amount of power and/or data cabling. Whenever seats are reconfigured, pre-loomed power cables must be unplugged before a seat is moved, plugged in again when the seat is reconfigured and cable looms must be gathered together and hidden, for both safety and aesthetic reasons. This procedure is cumbersome and time consuming. It is desirable to overcome or alleviate this problem by allowing for rapid reconfiguration of aircraft scats without the necessary requirement to couple and uncouple power cables. It is further desirable to enable changes in seat configuration without the need to deal with cable looms.

Many modern aircraft have seat tracks which allow for seats to be fixed along the track, to cater for changes in configuration. These may include anchor locations at, for example, one inch centres. When a seat is located at an anchor point, at present it is fixed by clamping the seat foot to the track, using a screw or a bolt. If the screw or bolt is not completely tightened, the assembly can rattle, causing undesirable noise and wear to the track. If sufficiently loose, the structural integrity of the seat mounting is compromised. It is desirable to provide a seat lock down system which does not suffer from this drawback.

The present invention aims to overcome or substantially alleviate the problems presently encountered with the prior art seat attachment systems. In one embodiment, the present invention aims to permit seat reconfiguration from, say, business class to full economy seat configuration for a commercial aircraft, in around two hours, This will involve reconfiguring a business class section of, say, ten rows of business class seats having seven seats per row to twenty rows of economy scats having ten scats per row. This represents a very significant improvement on prior art performance.

### DISCLOSURE OF THE INVENTION

Accordingly, this invention provides, in a first aspect, a track for a relocatable seat, the track including:
a first channel having a base and a plurality of first and second openings into the track, the first openings communicating with the second openings, the first openings being larger than the second openings, the first openings being adapted to receive a foot of the seat and the second openings being adapted to retain the foot; and
second and third channels, each adapted to receive and retain a power and/or data block, and each including a plurality of apertures for locking the power and/or data block to the track.

The invention, in a second aspect, provides a power and/or data block adapted to be locked into or unlocked from the second or third channel of the track of the invention, the block including power and/or data communication means, including a tongue adapted to be actuated to insert into or retract from one of the apertures in the track. Preferably, the power and/or data block is provided as part of a chain on a flexible harness, in sufficient numbers to cater for maximum configuration.

In a third aspect, the invention provides a releasable fastening system which includes:
first and second sled means adapted for insertion in a track;
a locking lever moveable between an open position and a locked position, the locking lever having a first end connected to the first sled means and a second end connected to the second sled means; and
means to engage the locking lever in the locking position;
   wherein each of the first and second sled means has an aperture inclined towards the track in use and wherein movement of the locking lever from the open position to the locked position is adapted to cause an object inserted in the aperture to travel down the incline of the aperture towards the track.

Preferably, the releasable fastening system is used to clamp a seat to a track.

The track of the invention is preferably used for a line of seats. Two or more such tracks may be required to support a rack of seats. The track may be provided as a flat base, in order to allow the track to be constructed in sections and embedded into an aircraft baseboard as required. The first channel preferably resembles the standard seat track used in the prior art. In this embodiment, the track of the invention can be retro-fitted to existing aircraft.

As an alternative, the track of the invention may be attached to or integrated with a structural beam which may be built into the aircraft from the outset, to enhance structural stability. In this embodiment also, the first channel may take the configuration of a standard seat track as known in the prior art. It is to be understood, however, that the first channel of the track of the invention can take various other configurations, whether included with a structural beam or not.

If the first channel resembles prior art standard seat tracks, the interconnecting first and second openings will be the same as or similar to those in the prior art, so that a seat foot may be inserted vertically into a first opening and slid forward or back so that it is retained within a second opening. Desirably, the seat foot is locked down in the chosen position using the releasable fastening system of the third aspect of the invention, as discussed further below.

The first and second openings may take any suitable shape. One example is illustrated in the drawings, discussed below.

The second and third channels are preferably disposed one on either side of the first channel. The second and third channels may be identical, except for one being a mirror image of the other. Preferably, each of the second and third channels includes an overhang lip, so that the power and/or data block may be slid horizontally into the second or third channel and restrained from vertical removal by the overhang lip.

The power and/or data communications means may take any suitable form. As examples, power may be provided by a multi-drop cable, or a daisy-chained connection, with discrete, moveable nodes at each seat connection point interconnecting with power or data feed nodes interconnected by wiring loop within or beneath the track. The connectors can be sealable, which can reduce electrical hazard.

As another option, power may be provided by seat-to-seat plug connection, using pluggable links between adjacent seat rows via connecting links inserted into the track. It will be appreciated that this will still avoid the problem of cable looms encountered in the prior art. It is possible to design linking elements which can also cover any unused track segments, enhancing aesthetics.

The track may include a bus bar, which can cater for infinitely adjustable seat connection, not, limited by node location.

Some data communication means will now be mentioned by way of example. Each of the examples is based on the use of a single integrated digital communications network which may satisfy all in-seat communications requirements, including attendant call, passenger warning/advisory indication, status monitoring, telephone, entertainment, Internet, etc.

The communications means may be a twisted pair copper cable. This comprises a high speed bi-directional network, such as 100baseT, running on twisted pair cable daisy-chained between seats, within impedance matching and signal regeneration by electrical box. This can be advantageous in that it may use standard technology available on existing aircraft.

Another example of communication means is daisy-chained coaxial cable. This can be daisy-chained between seats, with impedance matching and signal re-generation by electrical box. A discrete, movable node may be formed at each seat connection point for daisy-chained connections by electrical box to adjacent rows of seats. Connectors located in the track may provide uplink/downlink electrical connection to or from the electrical box. This may provide a higher bandwidth than the twisted pair example above.

A passive coupled coaxial cable may be used, coupling into seats using radio frequency modulated digital transmission. A discrete, movable node may be formed at each seat connection point, providing passive tee coupling located in the track for signal feed to the seat. This may also provide high bandwidth capability.

An optical fibre backbone with passive coupled optical fibre may be incorporated into each seat, providing bi-directional wideband communications over a single optical fibre. Once again, a discrete, movable node may be formed at each seat connection point, for daisy-chained connections to adjacent rows of seats. Each node can incorporate passive tee coupling to optical fibre for uplink/downlink and into the seat. It may be possible to achieve coupling via microbending. Very high bandwidth may be available through this option.

As a variation of the above example, an optical fibre backbone may be provided with copper-based electrical coupling into seats, providing bi-directional wideband communications over a single optical fibre. An optical-to-electrical conversion module may be provided at each connection point.

Another example is a leaky coaxial cable. A digitally modulated radio frequency communications network may be coupled to the seats using this type of cable, which can provide infinitely variable connection points.

A powerline carrier is another option. High speed bi-directional data is modulated onto a power fee system.

A wireless network is also within the scope of the invention. A wireless local area network, such as IEE802.11 G, can provide infinitely variable connection points via radio frequency link between seats and wireless access points.

The apertures for locking the power and/or data blocks to the track may take any particular form and may be located at any convenient area of the track. It is preferred, however, that the apertures are shaped to closely echo the shape of the tongue of the power and/or data block. It is further preferred that the apertures are located on an outer wall of the second and third channels.

The power and/or data block of the second aspect of the invention preferably allows the aircraft seat to be connected to power and/or data in any of a large choice of positions. Each block is preferably spaced at regular intervals on a flexible distribution harness which can be connected to the control system of the aircraft. The blocks connected to the distribution harness may be fed into the second or third channels from an open end of the channel and slid along the track, being retained therein by means such as the overhang lip referred to above. Preferably, the blocks are able to detect and indicate their correct position and lock into place. The seat assembly may then be located in the first channel and positioned to the relevant block or blocks.

The blocks preferably include fasteners with tongues which can lock into the apertures in the track. By way of example, the fasteners may be chosen from the range of fasteners disclosed in International Patent Application No PCT/AU2004/001580, the contents of which are incorporated herein by reference. The fastener referred to as a “beam” fastener may be used, for example. The fasteners may detect their correct position or location. Detection of the location may cause actuation of the fastener, so that the tongue locks into the aperture. The fastener of this embodiment may include means for sensing the correct position, for example a reader sensitive to information identifying the correct position. As an example, the correct position may be identified by a unique bar code and the fastener may include a bar code reader.

If desired, when the correct position has been detected, a visible signal may be emitted, such as the lighting up of a LED or emission of a peep noise.

Preferably, the power and/or data block is connected to a scat via a power and/or data connector.

When the seat assembly is located in the seat track and positioned to the relevant block or blocks, the seat is preferably locked down into the track. While various seat locking mechanisms may be used, it is preferred that the seat is caused to move vertically downwards and clamped in place by using the releasable fastening system of the third aspect of the invention.

In relation to the releasable fastening system of the third aspect of the invention, the first and second sled means preferably are connected, directly or indirectly, to the seat assembly. Preferably, each of the first and second sled means has two pairs of inclined apertures. In this embodiment, a foot of the seat assembly is inserted in each sled. Each foot has two pairs of lugs or protrusions inserted in the inclined apertures. When the locking lever is in the open position, the lugs are located at the top of the inclined apertures. In this position, the sled means may be designed to be clear of any power and/or data connector which is to be used to connect the power and/or data block to the seat. When the locking lever is moved to the locked position, the lugs are forced to travel down to the base of the inclined apertures, clamping the track between the foot and the sled means, so that data and/or power connectors on the seat foot or leg may engage the power and/or data blocks already in place in the track.

The locking lever is preferably hinged or pivotable approximately mid-way between the first and second ends, so that when in the open position the lever forms an angle with regard to the first and second ends and, when in the locked position, the lever lies in line with or close to a hypothetical line connecting the first and second ends.

The engagement means for engaging the locking lever in the locked position is preferably a fastener such as one of those disclosed in International Patent Application No PCT/AU2004/001580. One of the fasteners referred to as an “in-line” fastener in the international application may be useful, for example.

It is preferred that the fastener which holds the seat in position reports that the scat is locked down and that it is connected to power and/or data through the block or blocks, to the aircraft control system.

When it is desired to reconfigure the seat, the fastener in this embodiment is instructed to open, which releases the locking lever and the seat from the clamped-down position If the fastener is an in-line fastener, the mechanism is released to allow it to spring partially open. The locking lever is then opened fully manually, the seat data or power connectors are disengaged, the seat foot is moved from the second opening to the first opening in the first channel of the track and the seat can then be lifted vertically out of the track. Alternately, the seat can be slid along the track to the new position. Preferably, the fastener reports that it has been disengaged and, preferably, the block or blocks report that the seat has been disengaged from the power and/or data system.

Because it is important in aircraft to present a neat and streamlined appearance, it is desirable that a single seam carpet join is used in the region of the track, to give integration of the seat leg with the floor and to provide liquid-resistant protection for connections and the seat track locking mechanism. In this embodiment, in the space between consecutive seats, the carpet edges can join together and snap into the scat track to provide a single seam joint.

When seats are being installed or reconfigured, the power and/or data communication means is preferably plugged into the aircraft network. In this way, the work order and positioning instructions for the new seat configuration may be fed into the aircraft network and recognised by the power and/or data communication means. In this embodiment, if the system is effectively “instructed” as to the correct location of seats in the new configuration, the installer can be alerted by lights or sound (as referred to above) when each seat is in its correct position. At the same time, the power and/or data block can lock itself off as indicated above.

### BRIEF DESCRIPTION OF THE DRAWINGS

The invention will now be described in connection with certain non-limiting examples described in connection with the accompanying drawings, in which:

FIG. 1 is a perspective view of part of a typical track used in the prior art;

FIG. 2 is a perspective view of an embodiment of track (part only shown) according to the present invention;

FIG. 3 shows the track of FIG. 2 with a seat foot in locked down position and power and data blocks in place;

FIG. 4 is a cross-sectional view of the assembly of FIG. 3;

FIG. 5 is a cross-sectional side elevation of the embodiment of FIGS. 3 and 4, showing the releasable fastening system of the third aspect of the invention; and

FIG. 6 shows the same view as that in FIG. 5, but after manual release of the locking lever.

### DETAILED DESCRIPTION OF THE DRAWINGS

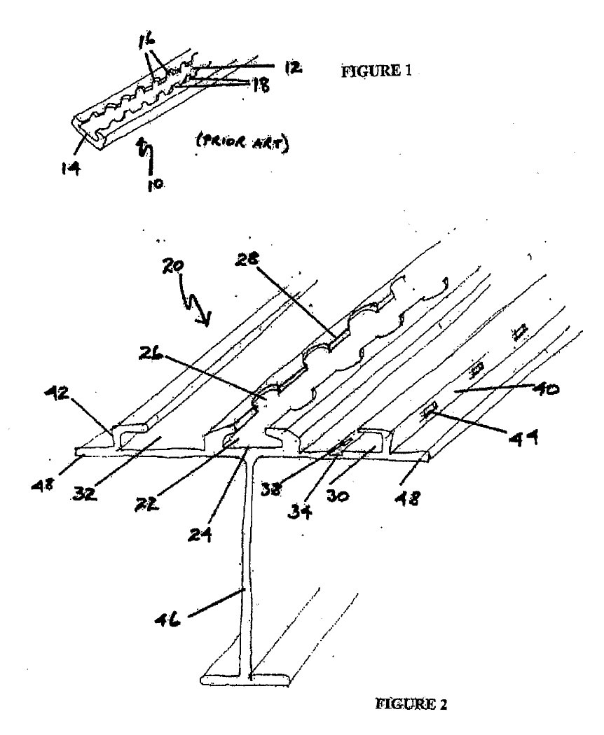

In FIG. 1 (prior art), track 10 has a single channel 12 having a base 14 with wide, first openings 16 and narrower, second openings 18. In the prior art, a seat foot (not shown) is inserted in one of the wider, first openings 16 and slid forward or back until the seat foot is retained under a second opening 18. At this stage, the foot is screwed or bolted down to base 14 of track 10.

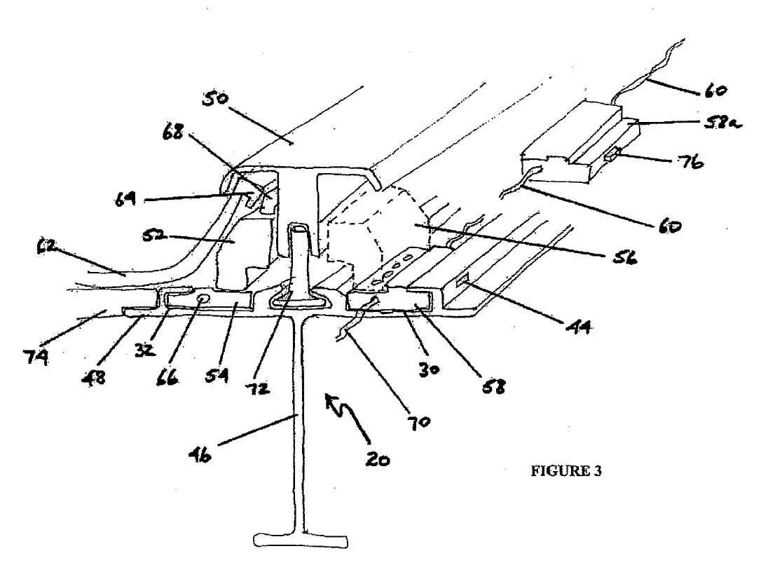

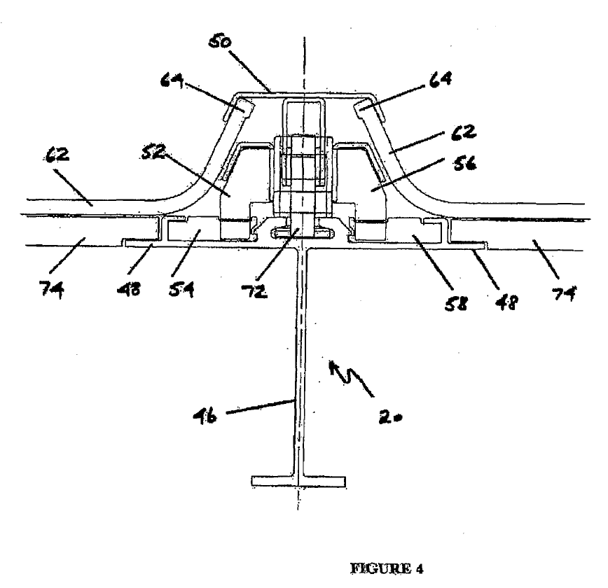

With reference to FIG. 2, track 20 of the present invention has a first channel 22 with a base 24 and first and second openings 26 and 28. First openings 26 communicate with second openings 28 (some only are indicated in FIG. 2). First openings 26 are larger than second openings 28, so that a seat foot (refer FIG. 3) may be inserted vertically in a first opening 26 and, when slid forward or back to the region of a second opening 28, may be retained in first channel 22, vertical removal of the seat foot being prevented.

Track 20 also includes second channel 30 and third channel 32. As can be seen from the Figure, the shape of second channel 30 is a mirror image of that of third channel 32.

Each of second channel 30 and third channel 32 is designed to receive and retain a power and/or data block (refer FIG. 3). Second channel 30 includes, in this embodiment, a tape 34. Located on tape 34 at spaced intervals are radio frequency identification nodes 38 (only one of which is illustrated and labelled).

On the outside vertical walls 40 and 42 of second channel 30 and third channel 32 respectively are oblong apertures 44 (only one of which is labelled). These act as indexing points for fasteners in the power and data blocks and provide the apertures for locking.

In this embodiment, track 20 is shown as integral with beam 46. Track 20 also includes floor board support flanges 48.

In FIG. 3, track 20 is shown with seat foot 50 in locked down position, connected by means of power connector 52 to power block 54 in third channel 32 and by means of data connector 56 to data block 58 in second channel 30 (data connector 56 being shown in dotted outline in this Figure). Data block 58 is shown connected in daisy chain fashion by harness 60 to other data blocks 58a etc in second channel 30. Power block 54 is similarly connected in daisy chain fashion to other power blocks (not shown) in third channel 32.

FIG. 3 shows power communication means in the form of cable 66 within power block 54. Power cable 68 connects the seat (not shown) through foot 50 to power block 54.

FIG. 3 also shows carpet 62 captured under foot 50 through the assistance of clip or zip 64

Data block 58 similarly includes data communication means in the form of cable 70 for providing data connection to the seat through data connector 56 to foot 50.

FIG. 3 shows how floor board 74 is supported by floor board support flange 48.

Data block 58a is shown with tongue 76 in the extended position. Data block 58 and power block 54 have similar tongues or locking means. Tongue 76 may normally be retracted until actuated to extend through one of apertures 44 when the relevant block reaches an assigned position.

FIG. 4, being a sectional view of the assembly of FIG. 3, is self-explanatory.

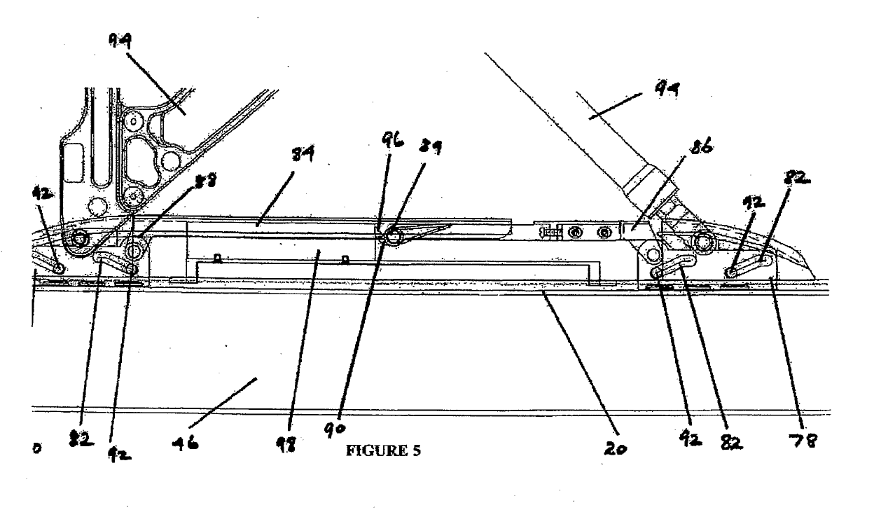

Turning now to FIG. 5, the releasable fastening system 100 of the third aspect of the invention is shown as having first sled 78 and second sled 80, both inserted in first channel 22 of track 20. Each of sleds 78 and 80 has two pairs of apertures 82, the corresponding aperture of each pair being on the other side of the sleds and not visible in this Figure. As can be seen, each aperture 82 is inclined downwardly towards track 20.

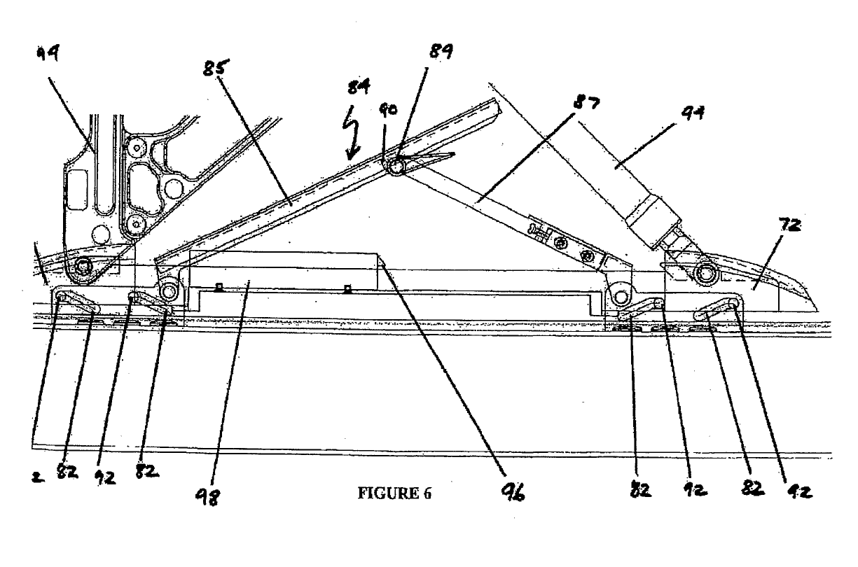

Locking lever 84 is formed in two parts 85 and 87 (refer FIG. 6), hinged at pivot point 89. Also pivotable around pivot point 89 is locking tongue 90. In the locked position shown in FIG. 5, locking tongue 90 engages tongue 96 of in-line fastener 98.

Lower part 72 of foot 50 (refer FIGS. 3, 4 and 6) includes lugs 92 which travel in apertures 82. In FIG. 5, lugs 92 are at the lowermost position in apertures 82, so that seat frame 94 has been caused to lower into track 20 when lever 84 is in the locked position. First end 86 of locking lever 84 is connected to first sled 78, while second end 88 of locking lever 84 is connected to second sled 80. The locking of lever 84 pushes first sled 78 apart from second sled 80 to the fullest extent allowable by the connections with first end 86 and second end 88, forcing lugs 92 to the lower most positions shown in FIG. 5. In the locked position, locking tongue 90 is engaged by tongue 96 of in-line fastener 98.

Consequently, after power block 54 and data block 58 have been locked into position as described above, seat frame 94 (and the rest of the seat assembly) is located in first channel 22 of track 20 and positioned to power connector 52 and data connector 56 Locking lever 84 is pushed downwardly into the locking position, from the configuration shown in FIG. 6 to that shown in FIG. 5. Lugs 92 travel down the incline of apertures 82, causing seat frame 94 to move downwardly, engaging power connector 52 and data connector 56 which in turn communicate with power block 54 and data block 58. The assembly is clamped in place and fastener 98 locks locking lever 84. At this stage, fastener 98 reports the connected and locked condition of the assembly.

As locking lever 84 is lowered, carpet clip 64 of carpet 62 is captured by seat foot 50 (refer FIGS. 3 and 4) and retained in position. Carpet edges between seats may then be engaged and snapped into the in-between portion of track 20. Once all seats have been installed, a program through the aircraft control system can control, via the seats, the cabin lights, seat numbers, etc. Seat numbers may be displayed on a screen on each seat, rather than having them shown in a fixed position on overhead lockers, etc.

If the seats are to be reconfigured, the aircraft control system is used to instruct fastener 98 to open and tongue 96 is disengaged from tongue 90. Lever 84 can then be manually moved to the open position shown in FIG. 6. Power connector 52 and data connector 56 may be removed and seat frame 94, with attached seat assembly, may be moved along rail 20 or lifted out of rail 20 via an opening 26. Power block 54 and data block 58 report their disengaged (seat unlocked) condition.

The embodiments in the drawings are given by way of illustration only. Changes may be made without departing from the spirit and scope of the invention.

### INDUSTRIAL APPLICABILITY

As will be readily appreciated by those skilled in the various arts, the inventions disclosed herein are not limited to the examples set out and have wide applications in many areas, representing significant advances in the relevant art. In particular, the inventions provide track, power/data block and releasable fastening systems particularly suitable for securing and releasing aircraft seats to the body of the aircraft which are far more sophisticated compared to prior art systems, permitting the application of modern technology.

1. A track for a relocatable seat, the track including:
a first channel having a base and a plurality of first and second openings into the track, the first openings communicating with the second openings, the first openings being larger than the second openings, the first openings being adapted to receive a foot of the seat and the second openings being adapted to retain the foot; and
second and third channels, each adapted to receive and retain a power and/or data block, and each including a plurality of apertures for locking the power and/or data block to the track.

2. The track of claim 1, wherein the second channel is disposed on one side of the first channel and the third channel is disposed on the other side of the first channel.

3. The track of claim 2, wherein the second channel is a mirror reverse of the third channel.

4. The track of any one of claims 1 to 3, wherein each of the second and third channels includes an overhang lip, adapted to restrain from vertical removal the power and/or data block having been slid substantially horizontally into the second or third channel respectively.

5. The track of any one of claims 1 to 4, wherein a plurality of the apertures is located on an outer wall of each of the second and third channels.

6. The track of any one of claims 1 to 5 when used for a rack of relocatable seats.

7. The track of any one of claims 1 to 6 which includes a structural beam.

8. A power and/or data block adapted to be locked into or unlocked from the second or third channel of the track of any one of claims 1 to 7, the block including power and/or data communication means and including a tongue adapted to be actuated to insert into or retract from one of the apertures in the track.

9. The block of claim 8, wherein the power and/or data communication means includes a daisy-chained connection, twisted pair copper cable, daisy-chained coaxial cable, leaky coaxial cable, optical fibre backbone, or wireless network.

10. The block of claim 8 or 9, which is provided as part of a chain on a flexible harness.

11. The block of any one of claims 8 to 10, in which the tongue is part of a fastener adapted to detect and indicate its position in relation to the track.

12. The block of any one of claims 8 to 11, when connected to a relocatable seat by a power and/or data connector.

13. A releasable fastening system including:
first and second sled means adapted for insertion in a track;
a locking lever moveable between an open position and a locked position, the locking lever having a first end connected to the first sled means and a second end connected to the second sled means; and
means to engage the locking lever in the locking position;
wherein each of the first and second sled means has at least one aperture inclined towards the track in use and wherein movement of the locking lever from the open position to the locked position is adapted to cause an object inserted in the at least one aperture to travel down the incline of the at least one aperture towards the track.

14. The releasable fastening system of claim 13, wherein the first and second sled means are connected, directly or indirectly, to a seat assembly.

15. The releasable fastening system of claim 13 or 14, wherein the locking lever is hinged or pivotable approximately mid-way between the first and second ends.

16. The relocatable fastening system of any one of claims 13 to 15, wherein each of the first and second sled means has two pairs of the inclined apertures.

17. The releasable fastening system of any one of claims 13 to 16, which is adapted to report locking status.

18. The releasable fastening system of any one of claims 13 to 17, wherein the track is as claimed in any one of claims 1 to 7

19. A track for a relocatable seat substantially as herein described with reference to FIG. 2 of the accompanying drawings.

20. A power and/or data block substantially as herein described with reference to FIGS. 3 and 4 of the accompanying drawings.

21. A releasable fastening system substantially as herein described with reference to FIGS. 5 and 6 of the accompanying drawings.
